(19) United States
(12) Patent Application Publication
(10) Pub. No.: US 2025/0034678 A1
(43) Pub. Date: Jan. 30, 2025

(54) RADIONUCLIDE GENERATION

(71) Applicants: SCK.CEN, Brussel (BE); VITO NV, Mol (BE); KATHOLIEKE UNIVERSITEIT LEUVEN, Leuven (BE)

(72) Inventors: Hongshan ZHU, Mol (BE); Stephan HEINITZ, Mol (BE); Steven MULLENS, Hasselt (BE); Koen BINNEMANS, Zele (BE); Thomas CARDINAELS, Mol (BE)

(21) Appl. No.: 18/717,078

(22) PCT Filed: Dec. 27, 2022
(86) PCT No.: PCT/EP2022/087876

§ 371 Date: Jun. 6, 2024

(30) Foreign Application Priority Data
Dec. 31, 2021 (EP) 21218490.7

(51) Int. Cl. C22B 30/06; C22B 3/24; G21G 1/00

(52) U.S. Cl. CPC C22B 30/06; C22B 3/24; G21G 1/001

(57) ABSTRACT

A radionuclide separating system for separating a ²¹³Bi daughter radionuclide from a ²²⁵Ac parent radionuclide, the radionuclide separating system comprising: an inlet for loading a liquid solution comprising the ²²⁵Ac parent radionuclide onto a column; the column comprising a sorbent material wherein the sorbent material is capable of interacting with the ²²⁵Ac parent radionuclide and ²¹³Bi daughter radionuclide so as to allow selective desorption of the ²²⁵Ac parent radionuclide and/or the ²¹³Bi daughter radionuclide at a different moment in time; and an outlet for selectively obtaining the ²¹³Bi daughter radionuclide based on the selective desorption of the ²²⁵Ac parent radionuclide and the ²¹³Bi daughter radionuclide, wherein the sorbent material is a carbon-based sorbent material.

### TECHNICAL FIELD OF THE INVENTION

The present invention relates to the field of radionuclides. More in particular, the present invention relates to a system and method for separating radionuclides, such as ²¹³Bi radionuclides.

### BACKGROUND OF THE INVENTION

The use of high-purity radionuclides has become increasingly crucial for diagnosis and medical treatment. In particular, targeted alpha therapy is a promising technology to treat various cancers and other diseases via alpha particle emissions. Compared with beta particles and Auger electrons, alpha particles are more effective ionization agents with a lower penetration range (50-100 m) and a higher linear energy transfer (50-230 keV/m), which maximizes the destruction of malignant cells with minimal damage to the surrounding normal tissues.

Recently, ²¹³Bi has emerged as a particularly promising alpha-emitter because of its high specific activity, effective half-life (t_{1/2}=45.6 min), high alpha-decay ratio, and absence of long-lived intermediates. Clinically, ²¹³Bi has been used to investigate the treatment of various cancers such as leukemia, malignant melanoma, brain tumors, and neuroendocrine tumors. In the prior art, the relatively long-lived parent nuclide ²²⁵Ac (t_{1/2}=9.92 d) has been applied as the direct source for the production of its short-lived daughter nuclide ²¹³Bi via ²²⁵Ac/²¹³Bi generators.

With a radionuclide generator, an effective radiochemical separation of decaying parent and daughter radionuclides may be performed such that the daughter is obtained in high radionuclidic and radiochemical purity. Typically, in a radionuclide generator system, a relatively long-lived radionuclide is used as the parent radionuclide; this decays to a daughter radionuclide with a shorter half-life. There are many advantages related to radionuclide generators, including 1) they may ensure the clinical availability of short-lived daughter radionuclides without relying on the production capability of nuclear reactors or accelerators; 2) they may provide short-lived daughter radionuclides with a high specific activity and in a carrier-free form, at a low cost; and 3) they may provide short-lived daughter radionuclides for medical application in hospitals that are located far away from nuclide production facilities. For example, the radionuclide generator may be present at the hospital, enabling generation of relatively pure samples of daughter radionuclides at the location where they are needed.

Two specific types of radionuclide generators known in the art are the direct radionuclide generators and the inverse radionuclide generators.

In a typical direct radionuclide generator, the column is filled with sorbents, i.e., sorbent material on which the parent isotope is adsorbed and from which the daughter isotope can be eluted at regular time intervals using different eluents. The sorbent material preferably has a high affinity for the parent isotope, and the generator eluate must be free from the parent isotope. Furthermore, the sorbent material in the radionuclide generator should promote a high and reliable (i.e., reproducible) yield, and a high purity of the daughter radionuclide to meet the increasing need for alpha-emitters in clinical studies.

In the inverse radionuclide generator system, the parent radionuclide is stored in a solution—typically a mixture comprising the parent radionuclide and a daughter radionuclide formed by the decay of the said parent radionuclide—, so that the effect of radiolytic damage on the performance of the sorbent material is reduced. As described in MCALISTER, D. R., and HORWITZ, E. P. Automated two column generator systems for medical radionuclides. Applied Radiation and Isotopes, 2009, 67 (11), 1985-1991, in the inverse radionuclide generator system, the solution, i.e., the mixture comprising daughter and parent radionuclides, is typically eluted through a chromatographic column specific for the desired daughter radionuclide (primary separation column, PSC). The daughter nuclide is retained on the PSC, while the parent passes through unretained. A small volume of rinse solution is then passed through the PSC to ensure near-complete recovery of the parent nuclide in an eluate. This eluate comprising the parent nuclide is then stored for further ingrowth of the desired daughter and future processing. The daughter nuclide is stripped from the PSC, and this strip solution is passed through a second column (guard column), which is specific for the parent nuclide. Thereby, the guard column may provide additional decontamination of the parent radionuclide from the daughter product, further improving the separation of the daughter radionuclide from the parent radionuclide, and thus resulting in a higher purity of daughter product.

Several sorbent materials (that are also known in the art as “resins”), are known in the art that may be used in the above described direct and/or inverse radionuclide generator systems. These sorbent materials typically, however, suffer from several disadvantages. For example, the separation properties of organic resins (such as the commercially available AG MP-50 and UTEVA) are affected by radiolytic damage, leading to a short lifetime on the column (the lifetime for AG MP-50 column loaded 100 mCi ²²⁵Ac was concluded to be no more than one day) (VASILIEV, A. N., et al. Radiation stability of sorbents in medical ²²⁵Ac/²¹³Bi generators. Solvent Extraction and Ion Exchange, 2021, 39 (4), 353-372). Several approaches have been proposed to overcome the (localized) radiolytic damage to the sorbent. US US2005/0008558A1 describes a method to distribute the radionuclide more homogeneously in the volume of packed resin, by adding complexing agents which avoid the concentration of the radionuclide in specific parts of the column. However, this approach is based on the use of highly concentrated acids, which might also impact the properties of the resin.

Another example of a sorbent is silica-based materials with impregnated or grafted functional groups. However, silica is leaching at low pH (typically pH<2) and may hence be unstable (YANTASEE, W., et al. Selective capture of radionuclides (U, Pu, Th, Am and Co) using functional nanoporous sorbents. Journal of hazardous materials, 2019, 366, 677-683; ABBASI, W. A., and STREAT, M. Sorption of uranium from nitric acid solution using TBP-impregnated activated carbons. Solvent extraction and Ion exchange, 1998, 16 (5), 1303-1320). Furthermore, silica-based resin structure was found to be slightly more affected by the radiation than resin comprising functional groups (VASILIEV, A. N., et al. Radiation stability of sorbents in medical ²²⁵Ac/²¹³Bi generators. Solvent Extraction and Ion Exchange, 2021, 39 (4), 353-372). Finally, the ²¹³Bi yield is relatively low (67-72%) for Isolute SCX-2 and Isolute SCX (MOORE, M. A., et al. The Performance of two silica based ion exchange resins in the separation of ²¹³Bi from its parent solution of ²²⁵Ac. Applied Radiation and Isotopes, 2018, 141, 68-72).

As a further example, sorbent material may comprise zirconia-based materials.

Disadvantages comprise leaching of the components of materials, e.g., T-39 (96% ZrO₂ and 4% Y₂O₃) in strong acid solutions (VASILIEV, A. N., et al. ²²⁵Ac/²¹³Bi generator based on inorganic sorbents. Radiochimica Acta, 2019, 107 (12), 1203-1211). Furthermore, there may be a decrease of the ²¹³Bi yield due to the accumulation of sorbent dissolution products in the solution: after 25 elutions, ²¹³Bi elution yield decreased to 50%. Such a decrease may not be acceptable for generator applications. In addition, it was found that 0.5-1% of ²²⁵Ac per elution were lost with the rinsing solution.

As a final example, PNNL (Pacific Northwest National Laboratory) has disclosed a Bi-generator with organic anion exchange resin (VASILIEV, A. N., et al. Radiation stability of sorbents in medical ²²⁵Ac/²¹³Bi generators. Solvent Extraction and Ion Exchange, 2021, 39 (4), 353-372; US005749042A). However, the generated ²¹³Bi sample, i.e., ²¹³Bi eluate, appears to contain an impurity of ²²⁵Ac, that is about 0.1% of its initial activity. Furthermore, 2-3% of the ²²⁵Ac is lost every milking with washing solution. Finally, the sorbent suffers from radiolytic damage.

There is thus still a need in the art for devices and methods that address at least some of the above problems.

### SUMMARY OF THE INVENTION

It is an object of the present invention to provide suitable materials, apparatus or methods for separating radionuclides.

The above objective is accomplished by a method and apparatus according to the present invention.

It is an advantage of embodiments of the present invention that the sorbent material may be mechanically, chemically, and radiolytically stable. It is an advantage of embodiments of the present invention that the sorbent material may not suffer from leaching issues. It is an advantage of embodiments of the present invention that the sorbent material may have a long lifetime. It is an advantage of embodiments of the present invention that the sorbent material may be used to separate high activity ²²⁵Ac/²¹³Bi. It is an advantage of embodiments of the present invention that the sorbent material may be used to obtain a high ²¹³Bi yield.

In a first aspect, the present invention relates to a radionuclide separating system for separating a daughter radionuclide from a parent radionuclide. The radionuclide separating system comprises an inlet for loading a liquid solution comprising the parent radionuclide onto a column. The radionuclide separating system further comprises the column, which comprises a sorbent material wherein the sorbent material is capable of interacting with the parent radionuclide and daughter radionuclide so as to allow selective desorption of the parent radionuclide and/or the daughter radionuclide at a different moment in time. Herein, the sorbent material is a carbon-based sorbent material. The radionuclide separating system further comprises an outlet for selectively obtaining said daughter radionuclide based on said selective desorption of the parent radionuclide and the daughter radionuclide. It is an advantage of embodiments of the present invention that the carbon-based sorbent material may be formed from an inert carbon material, which may provide good stability for the sorbent material. For example, carbon structures may have a high resistance against strong acid solutions (pH<2) in comparison with inorganic metal oxides. In addition, carbon structures with polycyclic aromatic rings may have higher radiation stability compared with organic resins.

In some embodiments, the carbon structures may have a good radiation stability compared to other organic sorbents, i.e. the carbon structures may have a higher half-value-dose than for most organic sorbents. The half-value-dose may be defined as the radiation dose at which 50% loss of exchange capacity for a given adsorbent occurs. A full definition of the half-value-dose may be found in technical report Radiation effects on ion exchange materials in BNL-50781 by Gangwer T E et al., Brookhaven National Lab., published on 1977 Nov. 1. In some embodiments, the carbon structures may have a half-value-dose of at least 10 MGy.

The inert carbon material may e.g. be inert with respect to radionuclides and solvents. It is an advantage of embodiments of the present invention that separation techniques for radionuclides are obtained wherein the column used in the separation process does not suffer from radiolytic damage or suffers less from radiolytic damage compared to existing columns. It is an advantage of embodiments of the present invention that the carbon-based sorbent material may be used to separate high activity ²²⁵Ac/²¹³Bi (e.g., at least 100 mCi ²²⁵Ac) to meet the requirements in medical application due to its high radiation stability or the improved separation method.

Where in embodiments reference is made to carbon-based materials, reference may for example be made to inorganic carbon-based materials, for example, the unmodified (initial) carbon structures were produced by the pyrolysis of polymer or a polysaccharide at high temperature degrees, e.g. more than 300° C., e.g, more than 400° C., for example carbon-based materials having an H/C ratio (molar ratio) of less than 1, e.g. less than 0.9.

The column may be any column suitable for comprising the sorbent material. Typically, the sorbent material is comprised in a fluidic path between the inlet and the outlet. In embodiments, the column may be a chromatographic column, as is well-known in the art. The volume of the sorbent material may be any suitable volume and may be selected as suitable for the application envisaged. In some embodiments, a volume of the carbon-based sorbent material may, for example, be from 0.1 to 10 mL. Preferably, the amount of sorbent material that is packed in the column is as small as possible. Typically, the lower the bed volume of the column, the higher the concentration of isotope, i.e., daughter radionuclide, that can be obtained.

In embodiments, the carbon-based sorbent material comprises, e.g., substantially consists of, an active material, e.g., active carbon, with one or more compounds containing one or more functional groups. In embodiments, one or more functional groups may be grafted or impregnated. Preferably, the functional groups are grafted, which may result in good stability of the functional groups in the carbon-based sorbent material. It is an advantage of these embodiments that the sorption affinity may be specifically optimized for the parent radionuclide and/or for the daughter radionuclide. At the same time, these embodiments may also provide high radiolytic stability.

In embodiments, the one or more functional groups are selected from: one or more oxygen-containing groups, e.g., carboxyl, hydroxyl, carbonyl, or epoxide; and/or one or more sulfur-containing groups, e.g., sulfonic acid, sulfoxide, or sulfone; and/or one or more phosphorous-containing groups, e.g., phosphate, phosphinate, phosphonate, or phosphine oxide. In embodiments, the functional groups may be selected from: —COOH, —C—OH, —C═O, —PO₄H, and —SO₃H. It is an advantage of these embodiments that one or more functional groups can be used for tuning the interaction between the sorbent material and the radionuclides, and thus for tuning the radionuclide separating system. That is, one or more functional groups may be used to optimize the sorbent material for use in a direct radionuclide separating system, or in an inverse radionuclide separating system. Introduction of different functional groups (e.g., —COOH, —C—OH, —C═O, —PO₄H, and —SO₃H) may be used to tune the mechanism of interaction, e.g., with ²¹³Bi and/or ²²⁵Ac metal ions, to obtain a sorbent material with suitable properties for a direct radionuclide separating system and/or for an inverse radionuclide separating system.

For example, functional groups may be used to tune an electrostatic interaction and/or an ion exchange of the carbon-based sorbent material with the nuclide. The electrostatic interaction and/or ion exchange may have a high sensitivity—and therefore, possibly, tunability—to the solution pH, the ionic strength and/or salt concentration. The electrostatic interaction and/or ion exchange mechanisms may be the dominant sorption mechanism for ²²⁵Ac, and also ²¹³Bi can interact with such functional groups (e.g., —COOH, —C—OH, —C═O, —PO₄H, and —SO₃H). With respect to these mechanisms, the following functional groups have been found to have some particularly good properties: sulphonic acid groups, carboxylic acid groups, and bis(2-ethylhexyl) phosphate.

In another example, the functional groups may be used to achieve inner-sphere complexation of a radionuclide (e.g., parent nuclide and/or daughter nuclide) with a phosphate group (—PO₄H), a carbonyl (—C═O), hydroxyl group (—C—OH), and carboxylic acid (—COOH). For example, as mainly ²¹³Bi interacts, i.e., forms complexes, with these functional groups, ²¹³Bi may have a stronger affinity, in this respect, compared to ²²⁵Ac.

In embodiments, the carbon-based sorbent material comprises one or more of: a pyrolyzed polymer or a polysaccharide, e.g., cellulose, cellulose derivatives, starch or phenolic resins; an activated carbon; a graphitic carbon nitride; a graphite carbon (that is, substantially consisting of carbon); and a carbon molecular sieve. In some embodiments, the carbon-based sorbent material substantially consists of one of these materials and possibly the functional groups. In some embodiments, the carbon-based sorbent material is an activated carbon or a carbon molecular sieve. In particular, polycyclic aromatic structures have higher radiation stability than other materials which are used as supports such as silica and organic resins. In some embodiments, the sorbent material is a polycyclic aromatic carbon structure, preferably with grafted functional groups. It is an advantage of these embodiments that the sorbent material may have a high radiolytic stability. This may be particularly advantageous for use in the radionuclide separating systems.

Examples of functionalized derivatives of carbon-based sorbent materials are sulfonated carbon materials, oxidized carbon materials, and carbon materials with impregnated extractants or cation exchange materials, e.g., bis(2-ehylhexyl)phosphoric acid impregnated activated carbon. Herein, the carbon material is applied as an inert support.

The shape of the sorbent material may impact the structural properties of the sorbent material, which may be a powder, and possibly also the presence of functional groups onto the surface. In embodiments, the carbon-based sorbent material is shaped in beads, or the carbon-based sorbent material is provided as a shell of beads, e.g., of spherical particles. Preferably, the sorbent material is shaped in spherical beads to ensure, for example, a uniform flow pattern in the column and a lower pressure drop over the column. In embodiments, the carbon-based sorbent material is shaped in beads having a size between 5 μm and 1 mm, for example between 10 μm and 500 μm, for example between 10 μm and 250 μm, for example between 10 μm and 150 μm, for example between 50 μm and 150 μm. It is an advantage of these embodiments that the column may be packed rapidly and that rapid purification may be achieved. It is to be noted that also other shapes can be used, aside the beads, such as for example including but not limited to extruded honeycombs, 3D-printed monoliths, tubular structures, non-spherical granules, and others.

In embodiments, the sorbent material may have a porosity between 0% and 70%. In embodiments, the pore size may be from 0 to 100 nm. In embodiments, the surface area of the sorbent material is smaller than 100 m²/g, for example less than 50 m²/g, for example, less than 25 m²/g, for example, less than 10 m²/g. It is an advantage of these embodiments that, due to the limited surface area, rapid purification may be achieved. A smaller surface area is desirable to avoid capture of isotopes inside the sorbent structure, which improves the elution efficiency by reducing the elution path.

For forming the carbon-based sorbent material, a carbon material for further functionalization may be selected. Functionalisation, in particular by grafting, may be easier for some carbon materials than for others. Preferably, the carbon material may have many defects in the carbon structure, or the carbon material may already have particular functional groups on its surface (e.g., activated carbon), which can be converted into the functional groups in accordance with embodiments of the present invention. Furthermore, functionalization via grafting imposes different requirements on the carbon material than impregnation. Next, the materials and processes used for radionuclide generation may be selected depending on the type of generator (i.e., inverse radionuclide separating systems or direct radionuclide separating systems). In particular, the sorption performance may be tuned by ionic strength and/or pH.

Although the invention is, in this description, mainly described with respect to ²²⁵Ac as the parent radionuclide and ²¹³Bi as the daughter radionuclide, the present invention is by no means to be interpreted as being limited to these embodiments. In embodiments, the radionuclide separating system is based on a decay of: ²²⁵Ac to ²¹³Bi; ¹¹³Sn to ^{113m}In; ⁸⁷Y to ^{87m}Sr; ²³²U to ²²⁸Th and/or to ²²⁴Ra and/or to ²²⁰Rn and/or to ²¹⁶Po and/or to ²¹²Pb; and ²²⁷Ac to ²¹¹Pb, or possibly of ¹⁹¹Os to ^{191m}Ir. Herein, as understood by the skilled person, the decay is of the parent compound to the daughter compound. Preferably, the radionuclide separating system is based on a decay of ²²⁵Ac to ²¹³Bi for separating ²¹³Bi radionuclides. It is an advantage of embodiments of the present invention that the technology can be applied for the generation of a plurality of radionuclides. It is an advantage of embodiments of the present invention that, for example, an elution of ²¹³Bi radionuclides can be high, compared to, e.g., elution of ²¹³Bi radionuclides using columns comprising sorbent materials according to the state of the art, e.g., silica-based materials. It is an advantage of embodiments of the present invention that the carbon-based sorbent material may be used to separate high activity ²²⁵Ac/²¹³Bi, e.g., at least 100 mCi ²²⁵Ac.

The affinities of the sorbent material for the parent radionuclide and daughter radionuclide may be dependent on pH and/or ionic strength of a solvent in contact with the sorbent, e.g., of the mixture or of an eluent. In embodiments, the sorbent material is capable of interacting with the parent radionuclide and daughter radionuclide so as to allow selective desorption of the parent radionuclide and/or the daughter radionuclide at a different moment in time comprises that the sorbent material has at least different affinities within a particular pH range and within a particular range of ionic strengths and/or salt concentrations, as is the case for carbon-based sorbent materials according to embodiments of the present invention.

In some embodiments, the radionuclide separating system is a direct radionuclide separating system, and the carbon-based sorbent material has a strong affinity for both the parent radionuclide and the daughter radionuclide, so as to selectively desorb the daughter radionuclide. In some embodiments, the mixture comprises parent nuclides and daughter nuclides, preferably at a low salt concentration, for example, the salt concentration less than 1.0 M, for example, the salt concentration less than 0.5 M. Preferably, the pH of the mixture is at least more than the pKₐ of the functional groups, for example, the pH is more than 1.47 for bis(2-ethylhexyl)phosphoric acid impregnated activated carbon, for examples, the pH is better more than 2 for bis(2-ethylhexyl)phosphoric acid impregnated activated carbon, so the parent nuclide would be adsorbed via electrostatic attraction and/or ion exchange.

Herein, the daughter radionuclide may be selectively desorbed using a first elution solution due to the daughter radionuclide more preferably interacts with elution ions than with the sorbent material, whereafter the parent radionuclide may be eluted by an acid solution for reuse and reduce the radiolytic damage to the sorbents.

The elution solution for the daughter radionuclide may comprise, preferably at least 0.1 M, such as at least 0.2 M, preferably at least 0.4 M, of NaI, NaCl, HI, HCl, or a combination thereof. In embodiments, the pH value of the elution solution may be at least, or more than, the pKₐ of main active sites. For examples, the elution solution may contain at least 0.45 M NaI at a pH of at least 2 for bis(2-ehylhexyl)phosphoric acid impregnated activated carbon.

The parent radionuclide may desorb from the generator column using the acidic solution, e.g., a HNO₃ solution or a HCl solution. The concentration of HNO₃ in said solution may be at least 0.1 M, preferably at least 0.2 M, such as from 0.1 to 0.5 M, preferably from 0.2 M to 0.3 M. It is an advantage of embodiments of the present invention that a reduced contact time of ²²⁵Ac with the carbon-based sorbent material, and an even distribution of the ²²⁵Ac over the column may be achieved, which may improve the lifetime of the column. It is an advantage of embodiments of the present invention that the parent isotope ²²⁵Ac is able to be eluted by relatively weak acid solution from the column to reuse next time.

In alternative embodiments, the radionuclide separating system may be an inverse radionuclide separating system, the carbon-based sorbent material being adapted for having a higher affinity for the daughter radionuclide than for the parent radionuclide. In embodiments, the carbon-based sorbent material comprises one or more of a phosphate group, a phosphonic group, a phosphinic group, carbonyl, a hydroxyl group, or a carboxylic acid group. These functional groups may result in the sorbent material having a higher affinity for the daughter radionuclide than for the parent radionuclide. In embodiments wherein the radionuclide separating system is the inverse radionuclide separating system, the radionuclide separating system may comprise a second column having a sorbent material, e.g., AG MP-50 or Ac resin, with higher affinity for the parent radionuclide than for the daughter radionuclide, an inlet, and an outlet. In embodiments, the outlet of the column may be configured to be fluidically coupled to an inlet of the second column when a strip solution, comprising the daughter radionuclide released from the column, is let out of the column. The sorbent material of the second column may not need a carbon-based sorbent material, as the daughter solution (that may cause most radiolytic damage) has a relatively short retainment time in the second column. However, also the sorbent material of the second column may comprise a carbon-based sorbent material, for which features may be independently as correspondingly described for carbon-based sorbent material of the column. It is an advantage of embodiments comprising the second column that a higher purity daughter radionuclide elution may be obtained, that is, comprising substantially no parent radionuclide.

Any features of any embodiment of the first aspect may be independently as correspondingly described for any embodiment of the second aspect of the present invention.

In a second aspect, the present invention relates to a method for separating radionuclides, the method comprising: loading a mixture of a parent radionuclide and a daughter radionuclide to a column comprising a carbon-based sorbent material; allowing the sorbent material to selectively interact with the parent radionuclide and the daughter radionuclide, the sorbent material having an affinity for interacting with the parent radionuclide and daughter radionuclide so as to allow selective desorption of the parent radionuclide and the daughter radionuclide; and selectively desorbing the parent radionuclide and the daughter radionuclide after said interaction, so as to selectively obtain the daughter radionuclide. In embodiments, the method may be performed using a radionuclide separating system as described with respect to the first aspect of the present invention.

In embodiments, the mixture may comprise the parent radionuclide and the daughter radionuclide dissolved in water. It is an advantage of water that its pH may be easily adjusted, and furthermore, that ions may be dissolved efficiently and at high concentrations.

In embodiments, the different moments in time may comprise that selective desorption of the parent radionuclide and/or the daughter radionuclide may be performed subsequently in time.

These embodiments may relate to a direct radionuclide generator, e.g., using a direct radionuclide separating system. The sorbent material is adapted so that the sorbent material has a strong affinity for both the parent radionuclide and the daughter radionuclide, so as to selectively desorb the daughter radionuclide, wherein said selectively obtaining the daughter radionuclide comprises, eluting the daughter radionuclide from the column using an eluent having a pH of at least more than the pKₐ of the functional groups on sorbents, after the parent radionuclide was bound to the sorbent material. Finally, the parent radionuclide, e.g., ²²⁵Ac, can be eluted by a solution comprising HNO₃, such as by a solution comprising HNO₃ at a concentration of from 0.1 to 0.5 M. Then the solution comprising the parent radionuclide may be stored and/or used as the mixture in a subsequent cycle. This step may also reduce the radiolytic damage for the sorbent via decreasing the contact time between the isotopes and sorbent, and it is easy to recycle and reuse the parent radionuclide, e.g., ²²⁵Ac.

These embodiments may relate to inverse radionuclide generation, e.g., using an inverse radionuclide separating system. In embodiments, the sorbent material is adapted so that the sorbent material has a higher affinity for the daughter radionuclide than for the parent radionuclide so as to preferably bind the daughter radionuclide, wherein said selectively obtaining the daughter radionuclide comprises rinsing the column, and thereafter stripping the daughter radionuclide from the column into a strip solution

In embodiments, the mixture may comprise NaNO₃ and HNO₃, preferably at a total concentration of NaNO₃ and HNO₃ higher than the ionic concentration of the strip solution, such as at least 2 M, preferably at least 3 M. The mixture may have a pH of less than 2, preferably less than 1.

The rinsing may, for example, be performed using an elution comprising NaNO₃ and HNO₃, preferably at a total concentration of NaNO₃ at least 2 M, preferably at least 3 M. The elution for the rinsing may have a pH of less than 2, preferably less than 1. The pH of rinsing solution may be less than the pH of mixture solution in the prior step. Preferably, the pH of rinsing solution may be same as the pH of mixture solution in the prior step. This may result in good sorption of the daughter radionuclide, e.g., ²¹³Bi, but not of the parent radionuclide, e.g., ²²⁵Ac.

In embodiments, the strip solution may comprise, for example, at a concentration of from 0.1 to 3.0 M, NaI, NaCl, HI, HCl or HNO₃ or a combination thereof. Preferably, the strip solution has a pH of at most 2. In embodiments, the strip solution may comprise from 0.1 to 3.0 M NaI at a pH of at most 2, or from 0.1 to 3.0 M NaCl at a pH of at most 2, or from 0.1 to 3.0 M HCl. Herein, HNO₃ may be used to adjust the pH value of the solution.

In some embodiments, sometimes the strip solution is further added to a second column having a sorbent material with a higher affinity for the parent radionuclide, that is, higher than for the daughter radionuclide, and eluting the daughter product, i.e., daughter radionuclide, from the second column, after interaction between the sorbent material of the second column and remaining parent radionuclide in the strip solution was allowed.

Any features of any embodiment of the second aspect may be independently as correspondingly described for any embodiment of the first aspect of the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change, and evolution of devices in this field, the present concepts are believed to represent substantial new and novel improvements, including departures from prior practices, resulting in the provision of more efficient, stable, and reliable devices of this nature.

The above and other characteristics, features, and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1A is a diagram of the K_{d}, at a range of pH values, for La³⁺ and Bi³⁺ between the solvent and sulfonated Norit CA1, sulfonated at a temperature of 80° C., in accordance with embodiments of the present invention.

FIG. 1B is a diagram of the K_{d}, at a range of pH values, for La³⁺ and Bi³⁺ between the solvent and sulfonated Norit CA1, sulfonated at a temperature of 150° C., in accordance with embodiments of the present invention.

FIGS. 1C and 1D are plots of the K_{d} as a function of an ionic strength of a mixture of parent radionuclides and daughter radionuclides applied to sulfonated Norit CA1, sulfonated at a temperature of 150° C., at a pH of 2 and 1, respectively, in accordance with embodiments of the present invention.

FIG. 1E is a diagram of the desorption percentage D (%) of La³⁺ and Bi³⁺ from sulfonated Norit CA1, sulfonated at a sulfonation temperature of 150° C.

FIGS. 1F and 1G are diagrams of the K_{d}, at pH 2 and 1, respectively, for La³⁺ and Bi³⁺ between the solvent and sulfonated Norit CA1, sulfonated at a temperature of 150° C., after receiving dose from ⁶⁰Co.

FIGS. 2A and 2B are diagrams of the K_{d}, at a range of pH values, for Bi³⁺ and La³⁺ with respect to graphitized carbon black (Carbopack X) and sulfonated graphitized carbon black, respectively.

FIGS. 3A and 3B are diagrams of the K_{d}, at a range of pH values, of Bi³⁺ and La³⁺ on Carboxen 572 and sulfonated Carboxen 572, respectively.

FIG. 4A is a diagram of the K_{d} of La³⁺ and Bi³⁺ with respect to sulfonated carbonized methyl cellulose, carbonized at a range of temperatures, and at a pH of 2.

FIG. 4B is a diagram of the R (%) of La³⁺ or Bi³⁺ with respect to sulfonated carbonized methyl cellulose, carbonized at a range of temperatures, and at a pH of 2.

FIG. 4C is a diagram of the K_{d} of La³⁺ or Bi³⁺ with respect to sulfonated carbonized methyl cellulose, carbonized at a range of temperatures, and at a pH of 1.

FIG. 4D is a diagram of the R (%) of La³⁺ or Bi³⁺ with respect to sulfonated carbonized methyl cellulose, carbonized at a range of temperatures, and at a pH of 1.

FIG. 5A is a diagram of the R (%) at a range of pH values for Bi³⁺ and La³⁺, with respect to the sorbent material activated carbon Norit CA1, in accordance with embodiments of the present invention.

FIG. 5B is a diagram of the high-resolution XPS oxygen is spectrum of Norit CA1.

FIGS. 6A and 6B are diagrams of the R (%) at a range of pH values, and the D (%) for different concentrations of NaI at pH 2, respectively, for Bi³⁺ and La³⁺, with respect to the sorbent material HDEHP-AC, in accordance with embodiments of the present invention.

FIG. 7A is a schematic representation of a conceptual design of, and a process flow for, an inverse ²²⁵Ac/²¹³Bi separating system, in accordance with embodiments of the present invention.

FIG. 7B is a schematic representation of a conceptual design of, and a process flow for, an inverse ²²⁵Ac/²¹³Bi separating system with a guard column.

FIG. 8A is a diagram of the K_{d} of Bi³⁺ and La³⁺ with respect to HDEHP-AC, for a range of ratios of S/L, with S the amount of sorbent material in milligram, and L the amount of the mixture in millilitre.

FIG. 8B is a diagram of the D (%) of Bi³⁺ and La³⁺ with respect to HDEHP-AC, for a range of concentrations of HNO₃.

FIG. 8C is a diagram of the R (%) of Bi³⁺ and La³⁺ with respect to HDEHP-AC, for a range of concentrations of NaNO₃.

FIG. 9 is a schematic representation of a conceptual design of, and a process flow for, a direct ²²⁵Ac/²¹³Bi separating system, in accordance with embodiments of the present invention.

FIG. 10A is a diagram of SEM images of cellulose beads, carbonized cellulose beads, and sulfonated carbonized cellulose beads.

FIG. 10B is a diagram of the K_{d}, at a range of pH values, of Bi³⁺ and La³⁺ on sulfonated carbonized cellulose beads.

FIG. 11 illustrates two systems for separating radionuclides, according to embodiments of the present invention.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. The term “comprising” therefore covers the situation where only the stated features are present and the situation where these features and one or more other features are present. The word “comprising” according to the invention therefore also includes as one embodiment that no further components are present. Thus, the scope of the expression “a device comprising means A and B” should not be interpreted as being limited to devices consisting only of components A and B. It means that with respect to the present invention, the only relevant components of the device are A and B.

Similarly, it is to be noticed that the term “coupled” should not be interpreted as being restricted to direct connections only. The terms “coupled” and “connected”, along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The following terms are provided solely to aid in the understanding of the invention.

As used in the context of the present invention, grafting functional groups, means that the chemical species are covalently bonded onto the solid surface, e.g., the surface of a sorbent material. As used in the context of the present invention, impregnation of functional groups means that the chemical species are physically distributed in the internal surface of the porous material.

As used in the context of the present invention, CMS is an abbreviation for carbon molecular sieve, and CNT is an abbreviation for carbon nanotube.

In a first aspect, the present invention relates to a radionuclide separating system for separating a daughter radionuclide from a parent radionuclide. The radionuclide separating system comprises an inlet for loading a liquid solution comprising the parent radionuclide onto a column. The radionuclide separating system further comprises the column, which comprises a sorbent material wherein the sorbent material is capable of interacting with the parent radionuclide and daughter radionuclide so as to allow selective desorption of the parent radionuclide and/or the daughter radionuclide at a different moment in time. Herein, the sorbent material is a carbon-based sorbent material. The radionuclide separating system further comprises an outlet for selectively obtaining said daughter radionuclide based on said selective desorption of the parent radionuclide and the daughter radionuclide.

In a second aspect, the present invention relates to a method for separating radionuclides, the method comprising: loading a mixture of a parent radionuclide and a daughter radionuclide to a column comprising a carbon-based sorbent material; allowing the sorbent material to selectively interact with the parent radionuclide and the daughter radionuclide, the sorbent material having an affinity for interacting with the parent radionuclide and daughter radionuclide so as to allow selective desorption of the parent radionuclide and/or the daughter radionuclide; and selectively desorbing the parent radionuclide and the daughter radionuclide after said interaction, so as to selectively obtain the daughter radionuclide.

By way of illustration, embodiments not being limited thereto, a schematic overview of a direct and inverse radionuclide separating system is shown in FIG. 11.

Several carbon-based sorbent materials, both for use in an inverse radionuclide separating system, and for use in a direct radionuclide separating system, in accordance with embodiments of the present invention, have been prepared and tested, as described below. Herein, although La³⁺ (as a substitute for a parent radionuclide) and Bi³⁺ (as daughter radionuclide) are used in the exemplary mixture, comprising water as a solvent, it is to be understood that, in particular, other parent and/or daughter radionuclides could be used as well. In particular, La³⁺ may be assumed to be replaceable by Ac³⁺ without considerably changing the results obtained and described below.

In the following examples, reference is made to R (%), which is a removal percentage. Furthermore, reference is made to D (%), which is a desorption percentage. Finally, reference is made to K_{d} (mg/L), which is a distribution coefficient, defined as the concentration ratio of a chemical between two media (e.g., between the sorbent material and the mixture of the parent radionuclide and the daughter radionuclide) at equilibrium. The removal percentage R (%), distribution coefficient K_{d} (mL/g), and desorption percentage D (%) may be calculated as follows:

$$R ( \% ) = \frac{{C}_{0} - {C}_{e}}{{C}_{0}} \times 100 \% \\ D ( \% ) = \frac{{n}_{s 1} - {n}_{s 2}}{{n}_{s 1}} \times 100 \% \\ {K}_{d} ( \% ) = \frac{{C}_{0} - {C}_{e}}{{C}_{0}} \times \frac{V}{m}$$

wherein m (g) is the mass of the adsorbents (i.e., the sorbent material). V (mL) is liquid phase volumes in the adsorption process, and Co (mol/L) and Cₑ (mol/L) represent the initial concentration and equilibrium concentration of La³⁺ or Bi³⁺ in the adsorption process, respectively. nₛ₁ (mol) and nₛ₂ (mol) represent the amount of La³⁺ or Bi³⁺ adsorption on the sorbent after the adsorption process and desorption process, respectively.

In what follows, examples are provided of carbon-based sorbent materials for use in an inverse radionuclide separating system. In the inverse radionuclide separating system, there is first selective adsorption of the daughter radionuclide (in the following examples, Bi³⁺) over the parent radionuclide (in the following examples, a substitute for the parent radionuclide, i.e., La³⁺) on the sorbent material. Next, desorption of the daughter radionuclide is performed from the sorbent material.

### Example 1

In this example, the sorbent material is activated carbon Norit CA1, with additional grafting by H₂SO₄ or HNO₃ treatment. Herein, the grafting results in an increase in oxygen content (both for H₂SO₄ and HNO₃ treatment), i.e., in the formation of carboxylic (and other) groups, and in an increase in sulphur content (for H₂SO₄ treatment), i.e., in the formation of sulphonic acid groups. For example, the sulfonated Norit CA1 (150° C.) was fabricated using concentrated H₂SO₄. Briefly, 15 g of Norit CA1 was mixed with 150 mL of concentrated sulfuric acid (95.0-98.0%) in a 500 mL round-bottomed flask and stirred for 10 min at room temperature. Then, the suspension was heated to 150° C. with continuous agitation and kept at that temperature for 3 h. After the suspension was cooled at room temperature, the obtained black products were filtered and intensively washed with deionized water until sulfate ions were no longer detected with barium chloride (addition of 5 drops of 1.0 M BaCl₂ to 1 mL of filtrate). Finally, the sample was dried in an oven at 70° C. The prepared product was designated sulfonated Norit CA1 (150° C.).

The functional groups of sulfonated Norit CA1 (150° C.) were investigated by XPS. The two main oxygen environments could be assigned to O═C (531.3 eV) and O—C (533.1 eV), representing a potential mixture of hydroxyl, carbonyl and carboxylate functional groups. In addition, this lower binding energy component becomes sharper, and more intense, which can then be assigned to overlapping sulfate/sulfonate and carbonyl environments. The sulfur 2p spectrum of sulfonated Norit CA1 (150° C.) showed a mixture of two overlapping sulfur environments that we have tentatively assigned to a mixture of sulfonate or sulfate (S 2p3/2 at 168.5 eV) and a lower oxidation state species such as sulfite or sulfinic acids (167.5 eV).

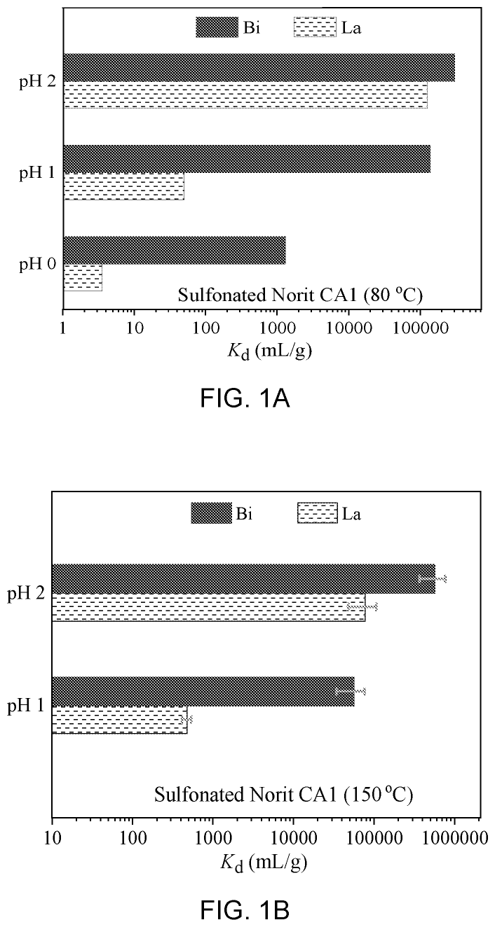

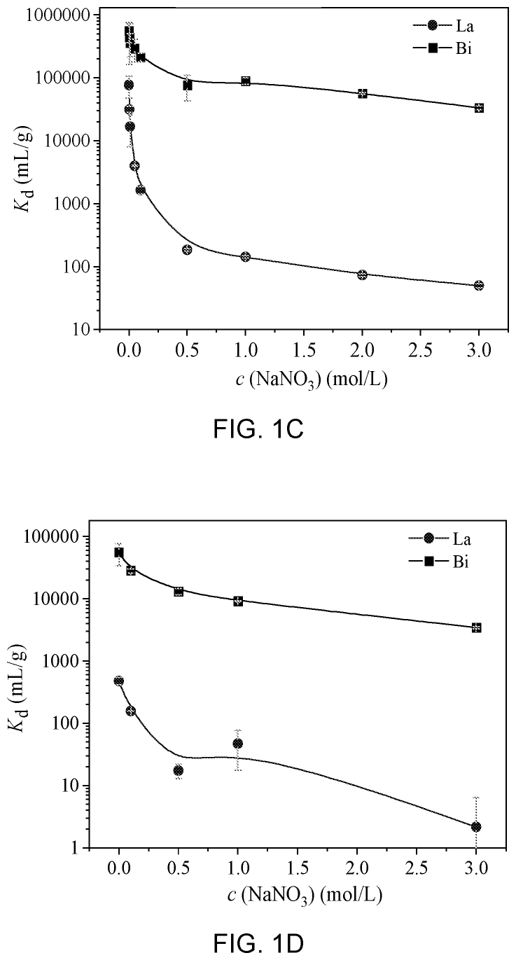

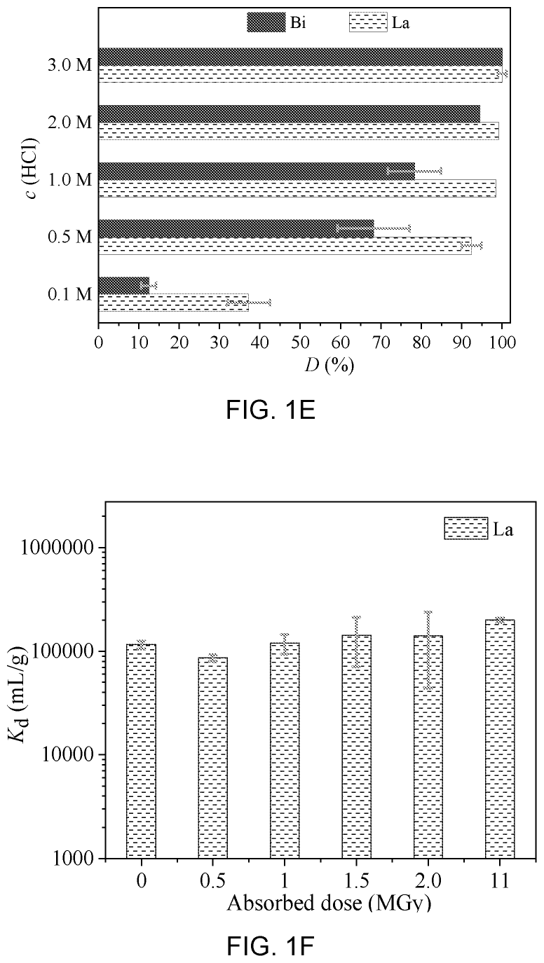

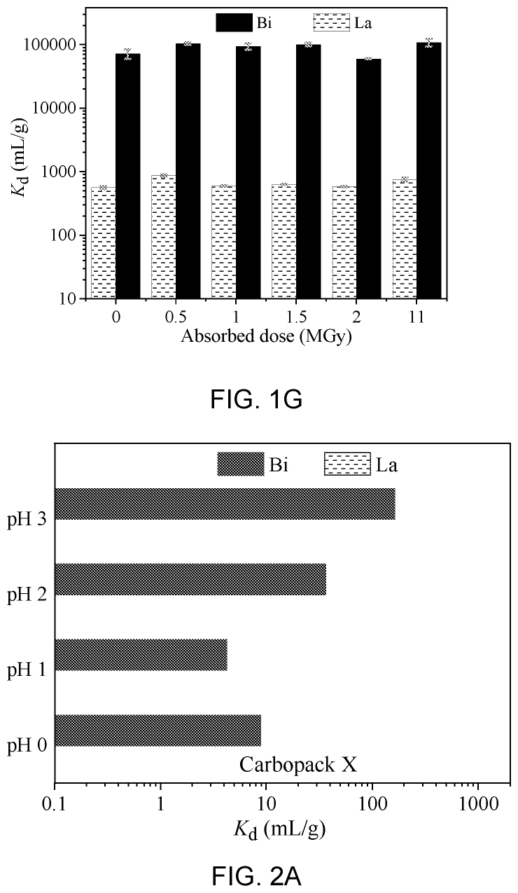

Reference is made to FIG. 1A, which is a diagram of the K_{d}, at a range of pH values, for La³⁺ and Bi³⁺ between the mixture, e.g., solvent (water), and sulfonated Norit CA1, sulfonated at a temperature of 80° C. Thereby, FIG. 1A indicates the effect of pH on the distribution coefficient of the sulfonated Norit CA1, sulfonated at a temperature of 80° C. Herein, the mixture of a parent radionuclide and a daughter radionuclide comprised 1.02 μmol/L of La³⁺ and 0.57 μmol/L of Bi³⁺. The amount of sorbent material was 20 mg and the amount of the mixture was 10 mL. The contact time was 24 h at room temperature. Further reference is made to FIG. 1B, which shows the effect of pH on the distribution coefficient for sulfonated Norit CA1, sulfonated at a temperature of 150° C., toward La³⁺ and Bi³⁺. Herein, the mixture of a parent radionuclide and a daughter radionuclide comprised 10 μmol/L of La³⁺ and 10 μmol/L of Bi³⁺. The amount of sorbent material was 10 mg and the amount of the mixture was 10 mL. The contact time was 24 h at room temperature. Further reference is made to FIGS. 1C and 1D, which shows the effect of ionic strength (e.g., NaNO₃) of a mixture comprising La³⁺ or Bi³⁺, on the K_{d} of said mixture with respect to sulfonated Norit CA1, sulfonated at a temperature of 150° C. Herein, the mixture of a parent radionuclide and a daughter radionuclide comprised 10 μmol/L of La³⁺ and 10 μmol/L of Bi³⁺. The amount of sorbent material was 10 mg and the amount of the mixture was 10 mL. Herein, the experiments for FIG. 1C were performed at a pH of 2, and those for FIG. 1D were performed at a pH of 1. It may be observed that higher selectivity in La³⁺/Bi³⁺ adsorption can be achieved by increasing ionic strength and decreasing pH. The explanation of this observation is that sulphonation leads to formation of oxygen-containing groups, which will participate in adsorption of both La³⁺ and Bi³⁺. As pH increases, both carboxylic and other groups, will become increasingly deprotonated, leading to more sorption sites (resulting in an increase in K_{d,Bi} and K_{d,La}). Additionally, the competition with H₃O⁺ (present at higher concentrations at lower pH) is increased. Furthermore, increasing the ionic strength may further result in less interaction of the carboxylic/sulphonic groups with La³⁺.

FIG. 1E shows the desorption percent of La³⁺ and Bi³⁺ from the sulfonated Norit CA1 (150° C.). With decreasing pH and increasing Cl⁻ concentration, desorption efficiency for La³⁺ and Bi³⁺ increased quickly at first then slightly, reaching 100% with 3 mol/L HCl elutions. The desorption mechanism is mainly ascribed to ion exchange selectivity reversal between the protons (H⁺) and La³⁺/Bi³⁺ under the acid environment and the complexation of Bi³⁺ and Cl⁻. Herein, the mixture of starting solution comprised 10 μmol/L of La³⁺ and 10 μmol/L of Bi³⁺ in a 10 mL solution. The amount of sorbent was 20 mg. Then different volumes (0.084-3.333 mL) of 12.0 mol/L HCl stock solution were added into to achieve an HCl concentration range of 0.1-3.0 mol/L.

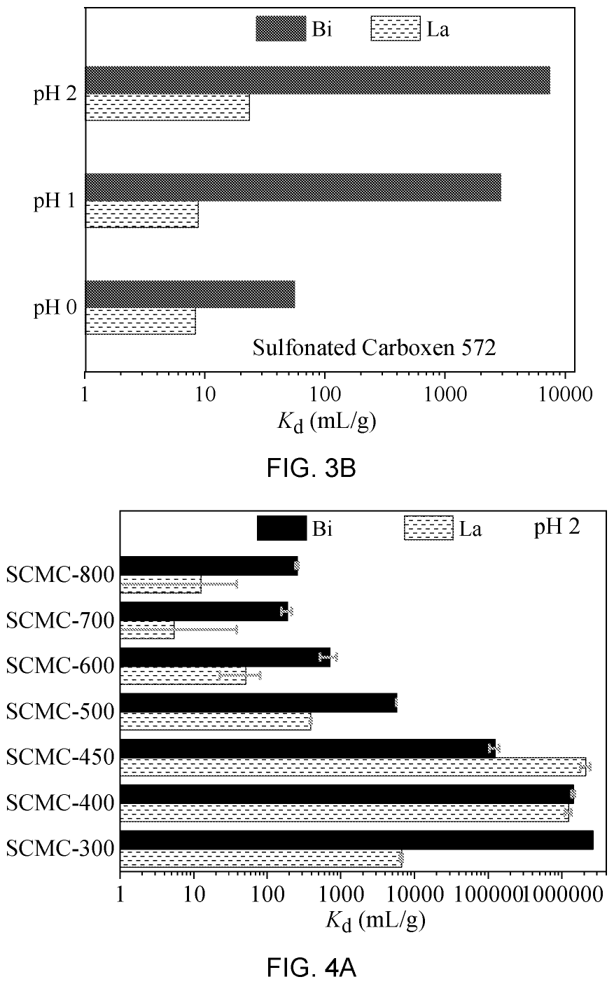

The radiation stability of sulfonated Norit CA1 (150° C.) was also investigated by exposing the sorbent to radiation and investigating the impact on the sorption performance. Briefly, the 200 mg sulfonated Norit CA1 (150° C.) was mixed with 2 mL of 1 M HCl solutions into 4 mL glass vials and irradiated by ⁶⁰Co. The received doses were from 0.5 to 11 MGy. References samples in 2 mL of 1 M HCl solutions without radiation treatment were also done. Finally, the samples were washed and dried in an oven and then used to study the sorption properties. Herein, the mixture of solution comprised 10 μmol/L of La³⁺ and 10 μmol/L of Bi³⁺. The amount of sorbent material was 10 mg and the amount of the mixture was 10 mL. Herein, the experiments for FIG. 3H were performed at a pH of 2, and those for FIG. 31 were performed at a pH of 1. It may be observed that there may be no noticeable decreasing change of the sorption performance, indicating no apparent change for the number of sorption sites.

### Example 2

In this example, the sorbent material comprised graphitized carbon black (Carbopack X) and sulfonated graphitized carbon black. Herein, the reaction conditions for the sulfonization are 5 g of Carbopack X in 50 mL 97% H₂SO₄ at 80° C. for 180 min, thereby forming the sulfonated graphitized carbon black, i.e., sulfonated Carbopack X.

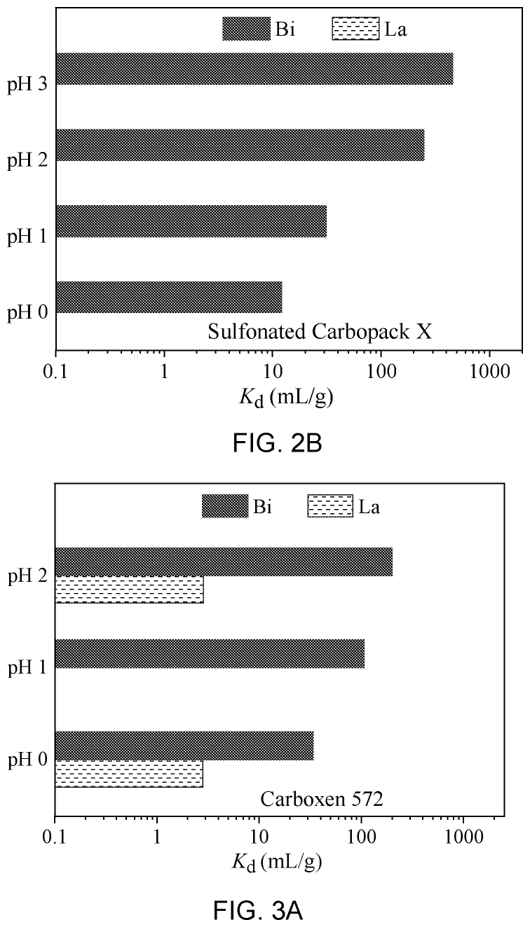

Reference is made to FIG. 2, which is a diagram of the K_{d}, at a range of pH values, for Bi³⁺ and La³⁺ between the solvent and the graphitized carbon black (Carbopack X) or sulfonated graphitized carbon black. As such, FIG. 2A shows the effect of pH on distribution coefficients of La³⁺ and Bi³⁺ with respect to Carbopack X. Further reference is made to FIG. 2B, which is a diagram of the K_{d}, at a range of pH values, for Bi³⁺ and La³⁺ between the solvent and the sulfonated Carbopack X. As such, FIG. 2A shows the effect of pH on distribution coefficients of La³⁺ and Bi³⁺ with respect to sulfonated Carbopack X. In both cases, the mixture comprised 1.01 μmol/L of La³⁺ and 0.57 μmol/L of Bi³⁺. The amount of sorbent material was 20 mg and the amount of the mixture was 10 mL. The contact time was 24 h at room temperature. It may be observed that there is nearly no sorption of La³⁺, there is low capacity for Bi³⁺ (compared to activated carbon) due to insufficient functional groups, but there is selectivity towards Bi³⁺ over La³⁺. After sulfonation, the sorption capacity for Bi³⁺ increased. After sulfonation, it was observed that the content of sulfur and oxygen slowly increased. A similar explanation for these observations may be assumed as with respect to Example 1 above.

### Example 3

In this example, the sorbent material is a Carbon Molecular Sieve [Carboxen 572]. Herein, sulfonated Carboxen 572 was synthesized using 2.5 g of Carboxen 572 in 25 mL of 97% H₂SO₄, at 150° C. for 240 min.

Reference is made to FIG. 3A, which is a diagram of the K_{d}, at a range of pH values, of Bi³⁺ and La³⁺ between the solvent and Carboxen 572, showing the effect of pH on distribution coefficients of La³⁺ and Bi³⁺ on Carboxen 572. Further reference is made to FIG. 3B, which is a diagram of the K_{d}, at a range of pH values, of Bi³⁺ and La³⁺ between the solvent and sulfonated Carboxen 572, thereby showing the effect of pH on the distribution coefficients of La³⁺ and Bi³⁺ with respect to sulfonated Carboxen 572. In both cases, a mixture of a parent radionuclide and a daughter radionuclide was used comprising a concentration of 1.0 μmol/L of La³⁺ and of 1.0 μmol/L of Bi³⁺. The amount of sorbent material was 25 mg, and the amount of the mixture was 10 mL. The contact time was 24 h at room temperature.

It may be observed that there is no sorption of La³⁺ for Carboxen 572. Furthermore, there is low capacity for Bi³⁺ and La³⁺ due to insufficient functional groups, but there is selectivity towards Bi³⁺ over La³⁺. After sulfonation, the sorption capacity for Bi³⁺ increased with the increase of sulfur and oxygen contents on the surface of sulfonated Carboxen 572. A similar explanation for these observations may be assumed as with respect to Example 2 above. A NaNO₃ solution could be employed to avoid La³⁺ adsorption on sulfonated Carboxen 572, as was also observed in the results of Example 1.

### Example 4

In this example, the sorbent material is sulfonated carbonized methyl cellulose (SCMC). Herein, the carbonized methyl cellulose is formed by carbonization of methyl cellulose at a range of temperatures. Below and in the figures, SCMC-[T] is used, wherein [T] indicates the temperature at which the methyl cellulose was carbonized. Herein, sulfonation was performed in 97% H₂SO₄, at 150° C. for 600 min.

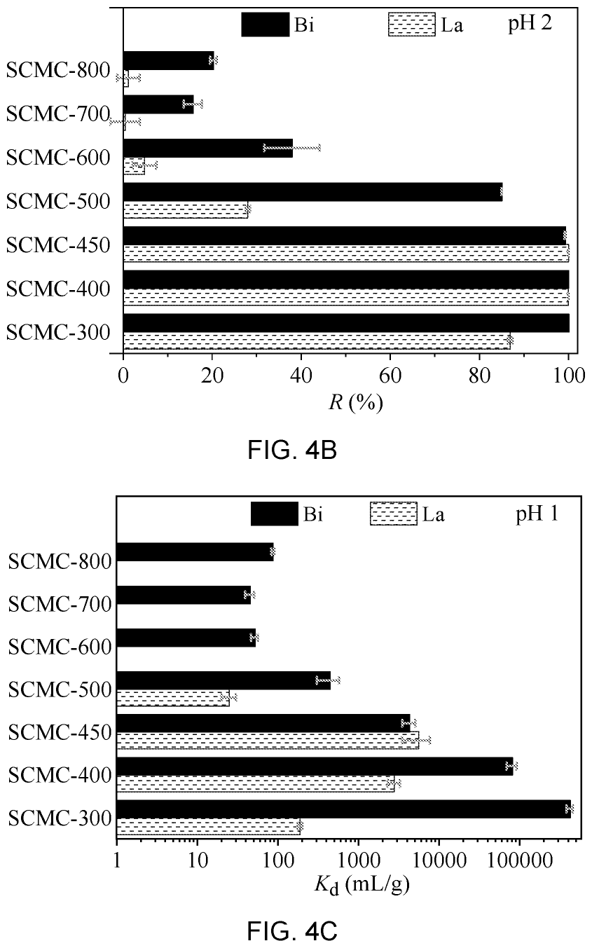

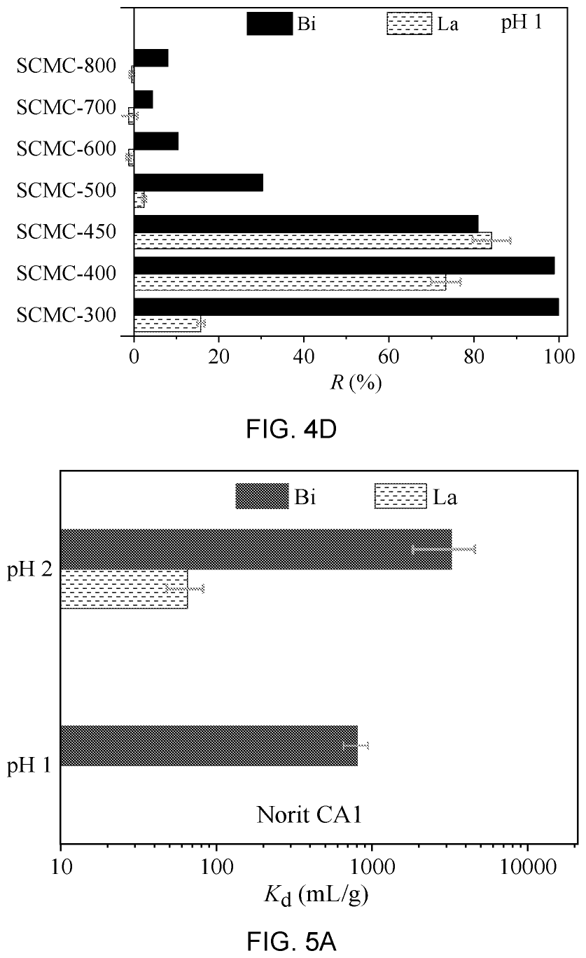

Reference is made to FIG. 4A and FIG. 4C, which are diagrams of the K_{d} of La³⁺ and Bi³⁺ with respect to sulfonated carbonized methyl cellulose, carbonized at a range of temperatures, and at a pH of 2 and 1, respectively. These diagrams show the effect of the carbonization temperature and pH on the adsorption coefficient of La³⁺ or Bi³⁺ on sulfonated carbonized methyl cellulose. Further reference is made to FIGS. 4B and 4D, which are diagrams of the R (%) of La³⁺ and Bi³⁺ with respect to sulfonated carbonized methyl cellulose, carbonized at a range of temperatures, and at a pH of 2 and 1, respectively. These diagrams showed the effect of the carbonization temperature on removal percentage of La³⁺ or Bi³⁺ on sulfonated carbonized methyl cellulose. For these experiments, the mixture of a parent radionuclide and a daughter radionuclide comprised 10 μmol/L of La³⁺ or 10 μmol/L of Bi³⁺. The amount of sorbent material was 10 mg, and the amount of the mixture was 10 mL. The contact time was 24 h at room temperature. It may be observed that some of the materials showed high sorption capacity for Bi³⁺ or La³⁺. The performance of SCMC-400 and SCMC-450 is definitively as good as the commercial ones (e.g., sulfonated Norit CA1). The sorption performance for sulfonated carbon materials with soft structures was better than for those with hard structures.

### Example 5

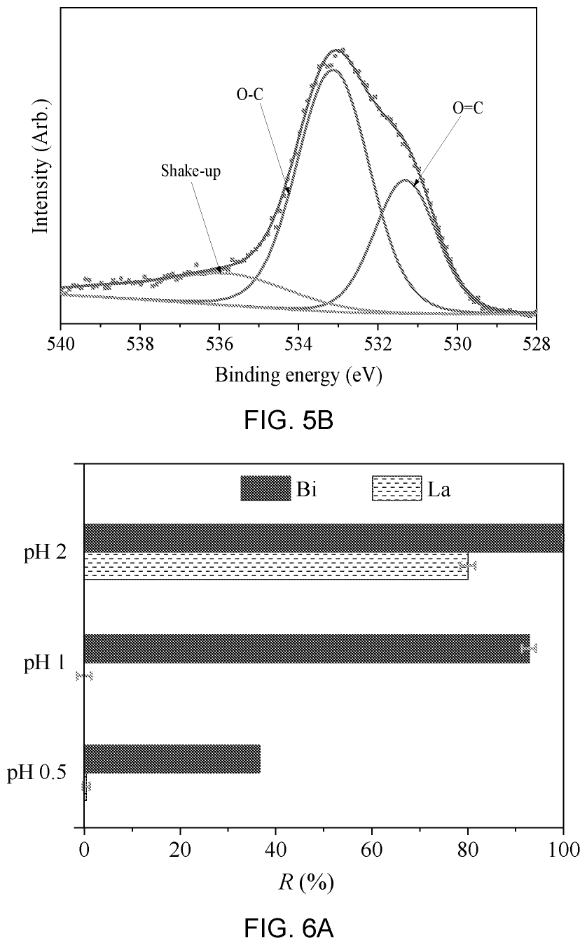

In this example, the sorbent material is activated carbon Norit CA1 (without additional functionalization, e.g., through grafting). Reference is made to FIG. 5A, which is a diagram of the R (%) at a range of pH values for Bi³⁺ and La³⁺, with respect to the sorbent material activated carbon Norit CA1. FIG. 5A, thereby, indicated that the effect of pH on adsorption percentages of Norit CA1 towards La³⁺ and Bi³⁺. In the experiments performed for the results shown in FIG. 5A, the mixture of a parent radionuclide and a daughter radionuclide comprised 10 μmol/L of La³⁺ and 10 μmol/L of Bi³⁺. The amount of sorbent material was 10 mg and the amount of the mixture was 10 mL, and the contact time was 24 h at room temperature.

It may be observed that at pH≤1.0, a high selectivity in La³⁺/Bi³⁺ sorption may be achieved (i.e., no sorption capacity for La³⁺, and high removal percentages for Bi³⁺). An explanation for this observation may be found in that this kind of activated carbon has different kinds of functional groups on its surface, allowing different interaction mechanisms with La³⁺ and Bi³⁺. XPS oxygen is spectra for Norit CA1 was shown in FIG. 5B. The two main oxygen environments could be assigned to O═C (531.3 eV) and O—C (533.1 eV), representing a potential mixture of hydroxyl, carbonyl and carboxylate functional groups.

### Example 6

In this example, the sorbent material comprised HDEHP-AC, i.e., bis(2-ethylhexyl)phosphate modified activated carbon. Bis(2-ethylhexyl)phosphate has the following chemical structure:

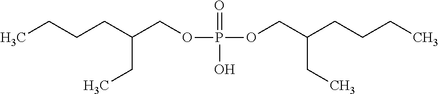 [SMILES: CCCCC(CC)COP(=O)(O)OCC(CC)CCCC]

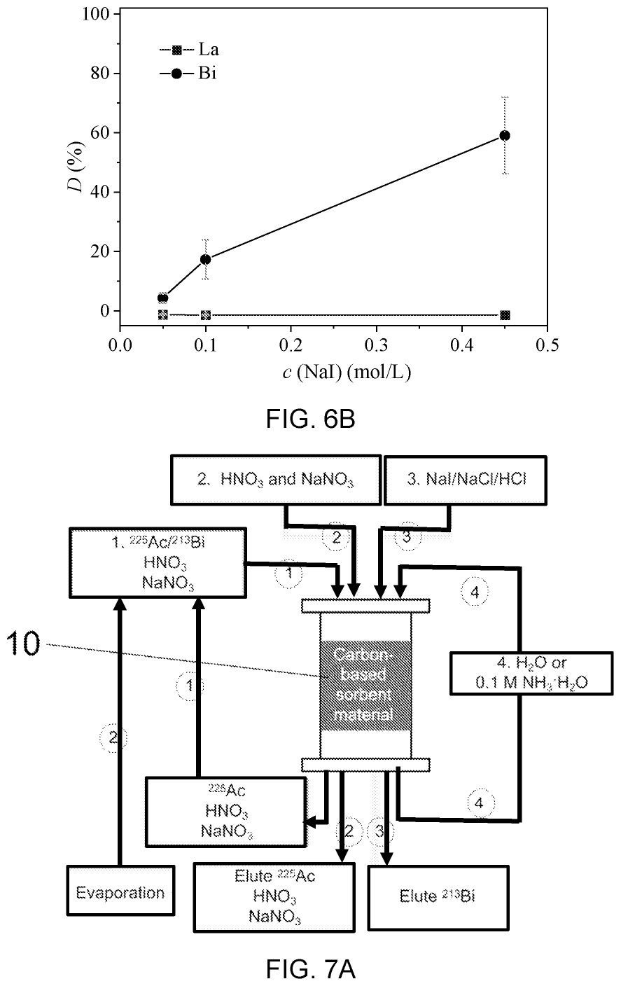

Reference is made to FIG. 6A, which is a diagram of the R (%) at a range of pH values for Bi³⁺ and La³⁺, with respect to the sorbent material HDEHP-AC. Thereby, FIG. 6A indicated the effect of pH on adsorption (i.e., removal) percentages of HDEHP-AC towards La³⁺ and Bi³⁺. Results indicated that the adsorption capacity for La³⁺ was much more sensitive to pH in a short range from 2 to 1, while Bi³⁺ exhibited relatively less dependence during this pH range. The percent removal for La³⁺ decreased rapidly from ˜80% at pH 2 to ˜0 at pH 1. At pH 2, high amounts of La³⁺ ions were adsorbed on HDEHP-AC via electrostatic attraction, ascribed to the deprotonated —PO₄H groups from HDEHP (pKₐ≈1.47). At pH 1, there was nearly no adsorption capacity for La³⁺ because of the interference of H⁺ ions and the lack of electrostatic attraction between HDEHP-AC and La³⁺ ions. It was also indicated that La³⁺ would be much easier desorbed due to ion-exchange with H⁺ in an acidic solution when pH<pKₐ. Compared to La³⁺, at pH 1, the removal percentage for Bi³⁺ was still more than 90% due to the complexation of Bi³⁺ with P═O and P—OH groups or hydrolysis of Bi³⁺ on the surface of HDEHP-AC. However, from pH 1 to pH 0.5, the removal percentage for Bi³⁺ decreased quickly from ˜93% to 37%; this is due to the electrostatic repulsion between Bi³⁺ and protonated functional groups, and the competitive adsorption of excess H⁺ ions. Based on the pH effect, one conclusion may be drawn that the HDEHP-AC can selectively uptake Bi³⁺ from La³⁺/Bi³⁺ mixture solution at low pH (e.g., pH 1). In summary, when the pH is at most 1.0, a high selectivity in La³⁺/Bi³⁺ sorption may be achieved (that is, nearly no sorption capacity for La³⁺, and high removal percentages for Bi).

Further reference is made to FIG. 6B, which is a diagram showing the D (%) for different concentrations of NaI with respect to the sorbent material HDEHP-AC. Results showed that the desorption percentage for Bi³⁺ was relatively higher at a high concentration of NaI solution at pH 2. Combined with the effect of pH, we may conclude that the NaI solution can be used to elute ²¹³Bi. Further, with the pH of elution decreasing, the ²¹³Bi may be increasing. Preferably, the pH of elution is at most 2.

Thereby, FIG. 6B shows the effect of elution concentration on desorption percentages of La³⁺ and Bi³⁺. For both examples, a mixture of a parent radionuclide and a daughter radionuclide was used comprising a concentration of La³⁺ of 10 μmol/L and a concentration of Bi³⁺ of 10 μmol/L. For FIG. 6A, the amount of sorbent material was 60 mg, the amount of the mixture was 30 mL, and the contact time (that is, between sorbent material and the mixture) was 24 h at room temperature, i.e., 25° C. For FIG. 6B, the amount of sorbent material was 400 mg, the amount of the mixture was about 30 mL, the pH of the mixture was 2, and the contact time was 24 h at room temperature.

### Example 7: General Principles of the Inverse Generator

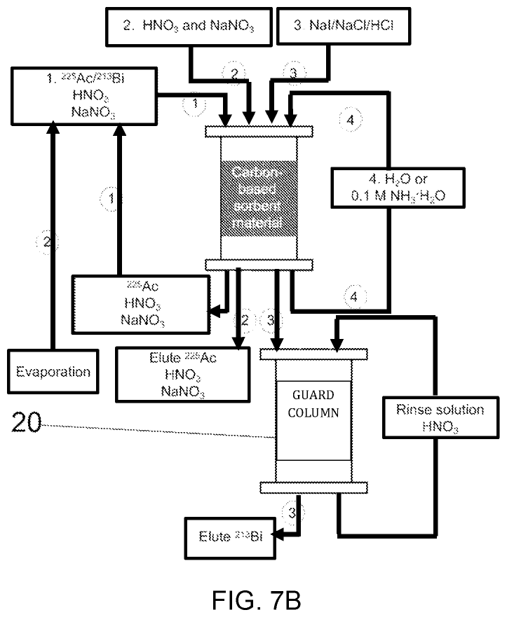

Reference is made to FIG. 7A, which is a schematic representation of a conceptual design of, and a process flow for, an inverse ²²⁵Ac/²¹³Bi separating system, illustrating more general principles in accordance with embodiments of the present invention. Although this example is specifically for separating ²¹³Bi from ²²⁵Ac, separation of other daughter radionuclides from other parent radionuclides may be performed in the same or similar systems, in accordance with embodiments of the present invention. Arrows, indicating direction of fluid (e.g., mixture/eluent/stripping solution/ . . . ) flow, with respective numbers, refer to the following method steps, which are in accordance with embodiments of the present invention.

Step 0 (preparation phase, not indicated): Based on the density of active sites for ²²⁵Ac and ²¹³Bi, the optimal ionic strength and pH range may be chosen. The column 10 is typically conditioned with HNO₃ (e.g., 0.1 M), which may be introduced through an inlet of the column.

Step 1: Then, the mixture of a parent radionuclide and a daughter radionuclide, comprising ²²⁵Ac (parent radionuclide) and ²¹³Bi (daughter radionuclide), is passed through the column 10, e.g., comprising introducing in the column 10 via an inlet. The mixture may further comprise, for example, NaNO₃, which may increase the ionic strength, and HNO₃, for reducing the pH. This may result in selective adsorption of ²¹³Bi on the sorbent material in the column 10, which is a carbon based sorbent material in accordance with embodiments of the present invention. An elution comprising ²²⁵Ac, HNO₃, and NaNO₃ may be removed through an outlet of the column 10.

Step 2: Subsequently, a small volume of a solution containing HNO₃ and NaNO₃ would be applied, e.g., through the inlet, to rinse residual ²²⁵Ac from the column 10, while ²¹³Bi remains adsorbed. The elutes of step 1 and 2, possibly after evaporation of the solvent of the elute of step 2, may be regenerated for use in the mixture in a step 1 of a subsequent cycle, thereby reducing waste of the process.

Step 3: ²¹³Bi may be eluted, by introducing through the inlet, an elution solution, i.e., strip solution, comprising NaCl, NaCl or HCl with lower ionic strength than that used for the sorption process 1. Indeed, if even a small mass of ²²⁵Ac from the high ionic strength solution is sorbed onto the column 10, it would be also difficult to elute this ²²⁵Ac when eluting the ²¹³Bi. The elute comprising ²¹³Bi may be collected through an outlet of the column 10, whereby the daughter radionuclide ²¹³Bi has been separated from the parent radionuclide ²²⁵Ac.

Step 4: To reuse the column 10, any Cl⁻ or I⁻ ions on the column may be eluted, i.e., removed, by rinsing the column 10 with, for example, H₂O or 0.1 M NH₃·H₂O.

To further ensure high purity of the eluted Bi (as preferably no Ac may be present in the elution), a second column 20 (guard column) may be introduced, comprising a sorbent material with higher affinity for the parent radionuclide than for the daughter nuclide, e.g., AG MP-50 or Ac resin. The presence of the second column 20 may not increase the separation time for ²¹³Bi. An example of an inverse ²²⁵Ac/²¹³Bi separating system comprising the second column 20 is shown in FIG. 7B. The arrows and numbers refer to the same method steps as explained above with respect to FIG. 7A. Herein, in step 3, the elute comprising ²¹³Bi, i.e., a strip solution, may be passed on from the outlet of the column 10 to an inlet of the second column 20. For example, the outlet of the column 10 may be fluidically coupled to the inlet of the second column 20. Subsequently, after interaction between the sorbent material of the second column and remaining parent radionuclide in the strip solution was allowed, the daughter radionuclide may be eluted from the second column 20, e.g., via an outlet of the second column 20.

For several of the carbon-based sorbent materials of the above Examples 1 to 7, the characteristics of the sorbent materials have been analysed using elemental analysis, to determine the carbon, sulphur and oxygen content in the respective materials. The results are summarized below in Table A.

TABLE A
Elemental analysis results

| | | | | | | | H/C (molar |
|---|---|---|---|---|---|---|---|
| Sorbent material | N (%) | C (%) | H (%) | S (%) | O (%) | P (%) | ratio) |
| HDEHP modified | 0.19 | 82.83 | 3.13 | <0.5 | 7.40 | 2.36 | 0.450 |
| activated carbon | | | | | | | |
| Norit CA1 | 0.43 | 70.41 | 3.54 | <0.5 | 15 | — | 0.555 |
| Sulfonated Norit CA1 | 0.34 | 69.01 | 3.96 | 2.21 | 29.63 | — | 0.684 |
| (150° C.) | | | | | | | |
| Carbopack X | 0.17 | 99.33 | 0.00 | 0.16 | 0.27 | — | 0 |
| Sulfonated Carbopack X | 0.17 | 96.78 | 0.00 | 0.37 | 1.28 | — | 0 |
| Carboxen 572 | 0.46 | 92.12 | 0.28 | 4.14 | 0.05 | — | 0.036 |
| Sulfonated Carboxen | 0.56 | 87.93 | 0.39 | 4.59 | 6.55 | — | 0.053 |
| 572 | | | | | | | |
| Carbonized methyl | 0.00 | 84.41 | 3.63 | <0.5 | 8.77 | — | 0.514 |
| cellulose (pyrolysis | | | | | | | |
| temp.: 400° C.) | | | | | | | |
| (CMC-400) | | | | | | | |
| Sulfonated CMC-400 | 0.00 | 65.46 | 2.65 | 2.72 | 28.65 | — | 0.482 |
| (SCMC-400) | | | | | | | |
| Carbonized methyl | 0.10 | 89.31 | 2.69 | <0.5 | 7.33 | — | 0.359 |
| cellulose (pyrolysis | | | | | | | |
| temp.: 500° C.) | | | | | | | |
| (CMC-500) | | | | | | | |
| Sulfonated CMC-500 | 0.00 | 69.57 | 2.66 | 4.86 | 22.71 | — | 0.458 |
| (SCMC-500) | | | | | | | |
| Carbonized methyl | 0.34 | 92.10 | 1.30 | <0.5 | 6.39 | — | 0.168 |
| cellulose (pyrolysis | | | | | | | |
| temp.: 700° C.) | | | | | | | |
| (CMC-700) | | | | | | | |
| Sulfonated CMC-700 | 0.08 | 79.75 | 1.44 | 3.88 | 15.40 | — | 0.215 |
| (SCMC-700) | | | | | | | |

In the above Examples 1 to 7, a range of sorbent materials, in combination with mixtures, were used. The present invention is, of course, not limited to these examples. Indeed, a range of optional technical features may be used to provide good properties to the sorbent material, as described elsewhere in this description.

In what follows, examples are provided of carbon-based sorbent materials for future use in a direct radionuclide separating system. In direct radionuclide separating system, there is first co-adsorption of the parent (in the following examples, a substitute for the parent radionuclide, i.e., La³⁺) and daughter radionuclide (in the following examples, Bi³⁺) on the sorbent material. Next, selective desorption of the daughter radionuclide (in the following examples, Bi³⁺) is performed from the sorbent material.

### Example 8

In this example, the sorbent material comprised HDEHP-AC.

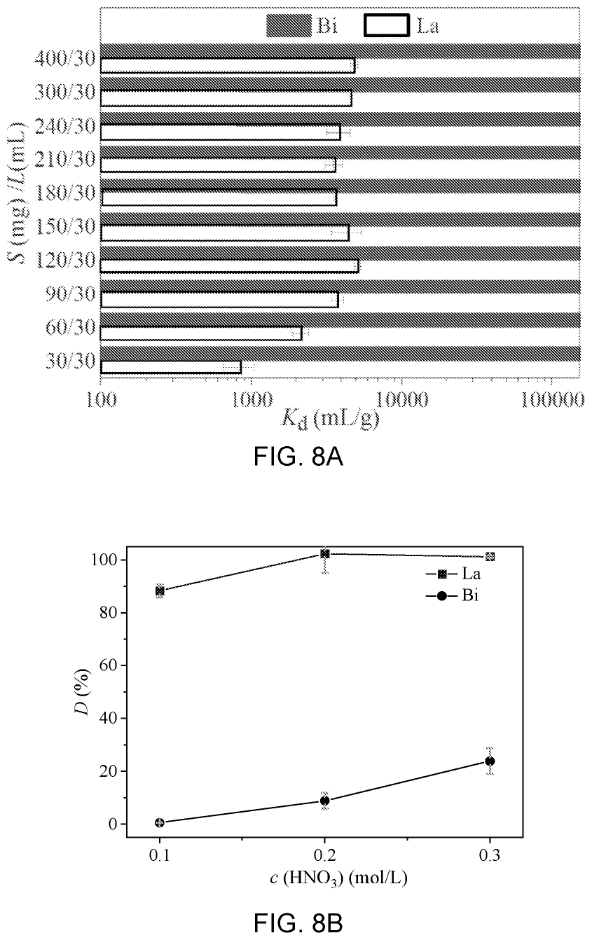

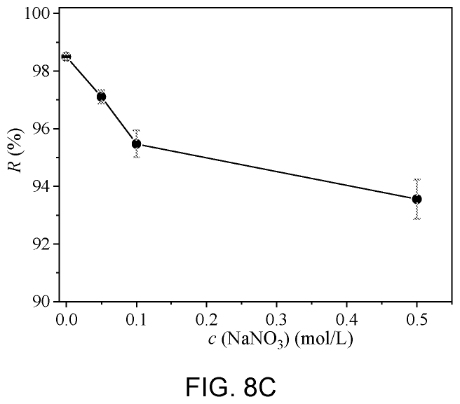

Reference is made to FIG. 8A, which is a diagram of the K_{d} of Bi³⁺ and La³⁺ with respect to HDEHP-AC, for a range of ratios of S/L, with S the amount of sorbent material in milligram, and L the amount of the mixture in milliliter. Herein, the effect of the amount (in mg) of sorbent material (S) over the amount (in mL) of the mixture (L) (i.e., mixture of a parent radionuclide and a daughter radionuclide) is shown on the distribution coefficients of La³⁺ and Bi³⁺ with respect to HDEHP modified activated carbon. Herein, the mixture comprised 10 μmol/L of La³⁺, and 10 mol/L of Bi³⁺. The experiments were performed at pH 2 with a contact time of 24 h at room temperature. The amount of sorbent material was 30-400 mg and the amount of the mixture was 10 mL. The experiments were performed at pH 2, with a contact time of 24 h, and at room temperature. Further reference is made to FIG. 6B in the example 6, which is a diagram of the D (%) of Bi³⁺ and La³⁺ with respect to HDEHP-AC, for a range of concentrations of NaI. Thereby, this diagram showed the effect of concentration of NaI, of the mixture on the desorption percentages of La³⁺ and Bi³⁺ from HDEHP modified activated carbon. Reference is made to FIG. 8B, which is a diagram of the desorption percentage of La³⁺ with respect to HDEHP-AC, after the Bi³⁺ desorbed from the surface of sorbent, various volumes of concentrated nitric acid were added into the tube to wash the La³⁺ to reuse La³⁺ (²²⁵Ac) and reduce the radiolytic damage for the sorbent. The concentration of nitric acid in the desorption process is in the range of 0.1 to 0.3 mol/L. Reference is made to FIG. 8C, which is a diagram of the adsorption percentage of Bi³⁺ and La³⁺ with respect to HDEHP-AC. Herein, the mixture of a parent radionuclide and a daughter radionuclide comprised 10 μmol/L of La³⁺, and 10 μmol/L of Bi³⁺. The concentration of NaNO₃ for the mixture is in the range of 0.1 to 0.5 mol/L.

In combination with FIG. 6A, it may be observed that for pH>pKₐ (1.47), the sorption capacity for La³⁺ increases with increasing pH. The Bi³⁺ may be easily eluted using a NaI solution at pH 2, without influencing the adsorption of La³⁺. Indeed, there may be strong complexation of I⁻ with Bi³⁺, leading to desorption. There seems to be no I⁻ complexation with La³⁺, so that La³⁺ remains adsorbed on the sorbent material.

In combination with FIG. 8B, after that, a acid solution (e.g., 0.2-0.3 mol/L HNO₃) would be used to elute the ²²⁵Ac to reduce the radiolytic damage for the column. Then obtained ²²⁵Ac can be used again after increasing the pH. The concentration of salt should not give a high influence for the sorption process according to the influence of ionic strength. Correspondingly, an alkaline solution would be added to increase the pH of the ²²⁵Ac solution to improve the sorption capacity of sorbents, which can lead to increasing the ionic strength. Here the effect of NaNO₃ concentration was studied to investigate the influence of ionic strength on the sorption performance of HDEHP-AC. FIG. 8C showed that the K_{d} values for La³⁺ gradually decreased with increasing the concentration of NaNO₃ from 0.05 to 0.5 mol/L. This was because the electrostatic attraction between La³⁺ and HDEHP-AC became weaker with increasing the ionic strength. Interestingly, the removal percentage for La³⁺ was still more than 90% in 0.5 mol/L NaNO₃ solution, implying that the HDEHP-AC still had a relatively good affinity for La³⁺ in a relatively high ionic strength solution. As for the Bi³⁺, the equilibrium concentration was below the lower detection limit of ICP-MS, so the K_{d} values for Bi³⁺ were still very high in the whole range, indicating that AC-P had an extreme affinity for Bi³⁺. This was due to the formation of inner-sphere complexes (Bi—OH/Bi═O) on HDEHP-AC.

### Example 9: General Principles of the Direct Generator

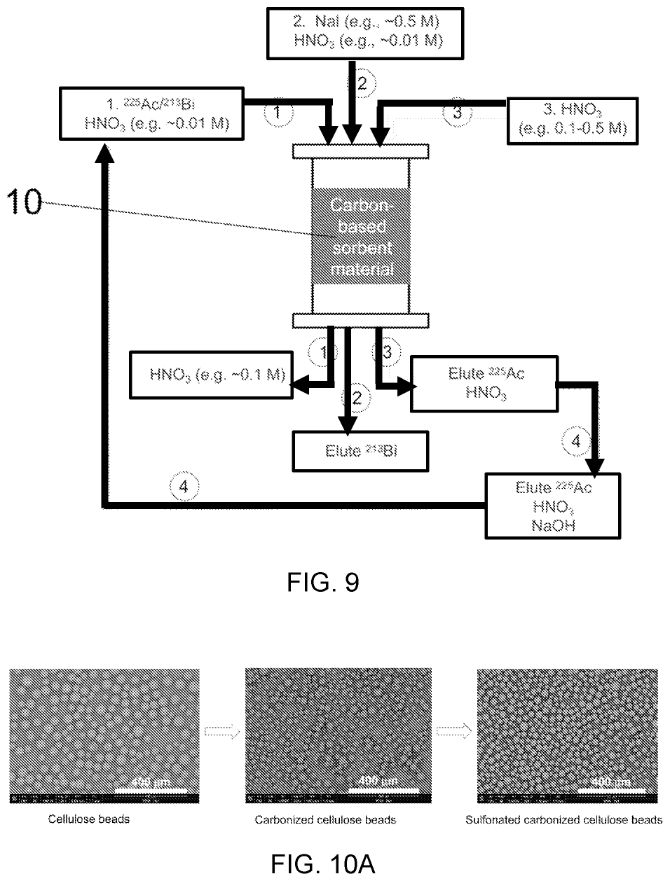

Reference is made to FIG. 9, which is a schematic representation of a conceptual design of, and a process flow for, a direct ²²⁵Ac/²¹³Bi separating system, in accordance with embodiments of the present invention. Although this example is specifically for separating ²¹³Bi from ²²⁵Ac, separation of other daughter radionuclides from other parent radionuclides may be performed in similar systems, in accordance with embodiments of the present invention. Arrows, indicating direction of fluid (e.g., mixture/eluent/stripping solution/ . . . ) flow, with respective numbers, refer to the following method steps, which are in accordance with embodiments of the present invention.

Step 0 (preparation phase): The sorbent materials may be conditioned with HNO₃ (e.g., at a concentration of at least 0.01 M). The mixture (that is, of a parent radionuclide and a daughter radionuclide) may be prepared with HNO₃ (e.g., >0.01 M) containing ²²⁵Ac and ²¹³Bi.

Step 1: The mixture may be introduced into the column 10, e.g., through an inlet. Both ²²⁵Ac and ²¹³Bi may be sorbed on the sorbent material of the column 10.

Step 2: An elution solution comprising NaI (e.g., at least 0.45 M) and HNO₃ (e.g., 0.01 M) may be introduced into the column 10 so as to elute ²¹³Bi. That is, the selectivity of the sorbent material may be increased by the elution solution having a large ionic strength.

Step 3: To increase the lifetime of the column 10, the ²²⁵Ac can be eluted by HNO₃ (e.g., a solution comprising HNO₃ at a concentration of from 0.1 to 0.5 M). Removing the ²²⁵Ac may reduce the contact time between ²²⁵Ac and the sorbent material.

Step 4: The pH of the ²²⁵Ac solution obtained in step 3 is preferably at least 2. This obtained ²²⁵Ac solution may be reused in step 0 of a next cycle for forming the mixture.

It is to be understood that although preferred embodiments, specific constructions and configurations, as well as materials, have been discussed herein for devices according to the present invention, various changes or modifications in form and detail may be made without departing from the scope of this invention. For example, any formulas given above are merely representative of procedures that may be used. Steps may be added or deleted to methods described within the scope of the present invention.

### Example 10

By way of illustration, embodiments not being limited thereto, an example of how spherical carbon materials can be synthesized is given. In this example, the spherical sulfonated carbon material was fabricated by pyrolysing the cellulose beads at 400° C. and then via a sulfonation process. The sulfonation temperature and sulfonation time was 150° C. and 180 min, respectively.

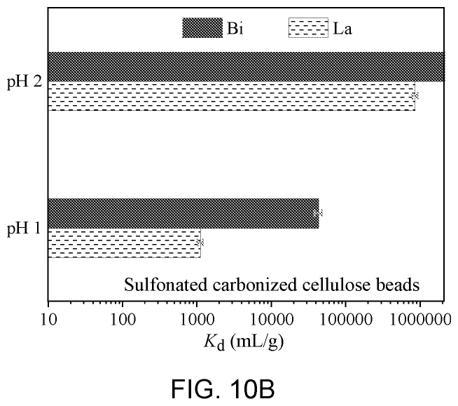

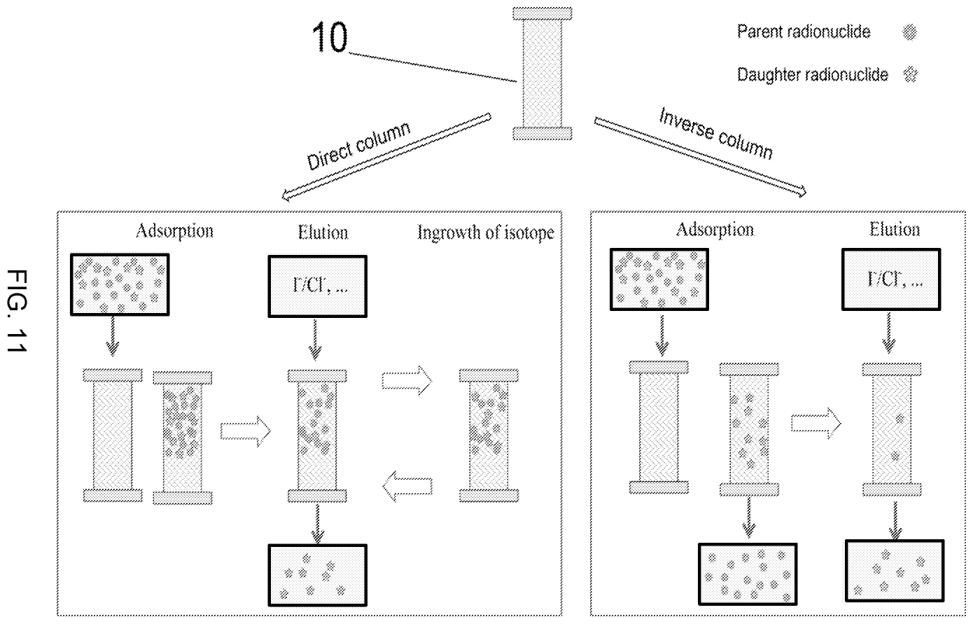

Reference is made to FIG. 10A, which is a diagram of the synthesis process. SEM images in FIG. 10A indicated that the spherical carbonized cellulose beads were synthesized successfully. This example showed a method to synthesize the spherical carbon materials and spherical sulfonated carbon materials.

Reference is made to FIG. 10B, which is a diagram of the K_{d} values at a range of pH values for Bi³⁺ and La³⁺, with respect to the sorbent material sulfonated carbonized cellulose beads, sulfonated at a temperature of 150° C. FIG. 10B, thereby, indicates the effect of pH on adsorption percentages of sulfonated carbonized cellulose beads towards La³⁺ and Bi³⁺. In the experiments performed for the results shown in FIG. 10B, the mixture of a parent radionuclide and a daughter radionuclide comprised 10 μmol/L of La³⁺ and 10 μmol/L of Bi³⁺. The amount of sorbent material was 30 mg and the amount of the mixture was 10 mL, and the contact time was 24 h at room temperature.

Further by way of illustration, the present invention not being limited thereto, an example of an experimental separation is described below. An ²²⁵Ac/²¹³Bi column was prepared with 100 mg of SCMC-500. The prepared 5 mL starting solution was composed of 200 kBq ²²⁵Ac, 0.055 mol L⁻¹ HNO₃ and 3.0 mol L⁻¹ NaNO₃. The columns were rinsed with H₂O (10 mL) and then 0.01 mol L⁻¹ HNO₃ solution (2 mL). Subsequently, the prepared ²²⁵Ac solution (5 mL) in a Falcon tube was passed through the column under a sorption flow rate of 1.4±0.1 mL min⁻¹. Thereafter, 1 mL of 0.02 mol L⁻¹ HNO₃/3 mol L⁻¹ NaNO₃ solution was applied to wash the Falcon tube, and then 2.5 mL of 0.02 mol L⁻¹ HNO₃/3 mol L⁻¹ NaNO₃ was utilized to wash the column-100. Finally, 1 mL of 1 mol L⁻¹ HCl was employed to elute the ²¹³Bi with an elution flow rate of 1.4±0.1 mL min⁻¹. The ²²⁵Ac impurity in the elution was 0.03±0.01% (the activity ratio of ²²⁵Ac to ²¹³Bi at the end of separation). The total separation time was 6.5±0.3 min. The ²¹³Bi yield was 94±3%.

1.-15. (canceled)

16. A radionuclide separating system for separating a ²¹³Bi daughter radionuclide from an ²²⁵Ac parent radionuclide, the radionuclide separating system comprising:
an inlet for loading a liquid solution comprising the ²²⁵Ac parent radionuclide onto a column,
the column comprising a sorbent material wherein the sorbent material is capable of interacting with the ²²⁵Ac parent radionuclide and ²¹³Bi daughter radionuclide so as to allow selective desorption of the ²²⁵Ac parent radionuclide and/or the ²¹³Bi daughter radionuclide at a different moment in time, and
an outlet for selectively obtaining said ²¹³Bi daughter radionuclide based on said selective desorption of the ²²⁵Ac parent radionuclide and the ²¹³Bi daughter radionuclide,
wherein the sorbent material is a carbon-based sorbent material.

17. The radionuclide separating system according to claim 16, wherein the carbon-based sorbent material comprises an active material with one or more compounds containing one or more functional groups.

18. The radionuclide separating system according to claim 16, wherein the one or more functional groups are selected from:
one or more oxygen containing groups; and/or
one or more sulfur containing groups; and/or
one or more phosphorous containing groups.

19. The radionuclide separating system according to claim 16, wherein the carbon-based sorbent material comprises one or more of:
a pyrolyzed polymer or a polysaccharide; and/or
an activated carbon, a carbon nitride, a graphitic carbon nitride, a graphite and a carbon molecular sieve.

20. The radionuclide separating system according to claim 16, wherein the carbon-based sorbent material is shaped in beads or
wherein the carbon-based sorbent material is provided as shell of beads, as a tubular structures, as honeycomb or as 3D printed monolith.

21. The radionuclide separating system according to claim 16, wherein the carbon-based sorbent material is shaped in beads having a size between 5 μm and 1 mm.

22. The radionuclide separating system according to claim 16, wherein the surface area of the sorbent material is smaller than 100 m²/g.

23. The radionuclide separating system according to claim 16, wherein the H/C molar ratio of the carbon-based sorbent material is lower than 1.

24. The radionuclide separating system according to claim 16, wherein the radionuclide separating system is a direct radionuclide separating system, the carbon-based sorbent material having a strong affinity for both the ²²⁵Ac parent radionuclide and the daughter radionuclide, so as to selectively desorb the daughter radionuclide.

25. The radionuclide separating system according to claim 16, wherein the radionuclide separating system is an inverse radionuclide separating system, the carbon-based sorbent material being adapted for having a higher affinity for the daughter radionuclide rather than to the ²²⁵Ac parent radionuclide.

26. The radionuclide separating system according to claim 25, wherein the carbon-based sorbent material comprises one or more of a phosphate group, carbonyl, a hydroxyl group or a carboxylic acid.

27. A method for separating radionuclides, the method comprising:
loading a mixture of a ²²⁵Ac parent radionuclide and a ²¹³Bi daughter radionuclide to a column comprising a carbon-based sorbent material,
allowing the sorbent material to selectively interact with the ²²⁵Ac parent radionuclide and the ²¹³Bi daughter radionuclide, the sorbent material having affinity for interacting with the ²²⁵Ac parent radionuclide and ²¹³Bi daughter radionuclide so as to allow selective desorption of the ²²⁵Ac parent radionuclide and the ²¹³Bi daughter radionuclide, and
selectively desorbing the ²²⁵Ac parent radionuclide and the ²¹³Bi daughter radionuclide after said interaction, so as to selectively obtain the ²¹³Bi daughter radionuclide.

28. The method according to claim 27, wherein the sorbent material is adapted so that the sorbent material has a higher affinity for the ²²⁵Ac parent radionuclide than the ²¹³Bi daughter radionuclide so as to bind the ²²⁵Ac parent radionuclide,
wherein said selectively obtaining the daughter radionuclide comprises, eluting the ²¹³Bi daughter radionuclide from the column using an eluent having a pH of at least 1 after the ²²⁵Ac parent radionuclide was bound to the sorbent material.

29. The method according to claim 27, wherein the sorbent material is adapted so that the sorbent material has a higher affinity for the ²¹³Bi daughter radionuclide than the ²²⁵Ac parent radionuclide so as to bind the ²¹³Bi daughter radionuclide,
wherein said selectively obtaining the ²¹³Bi daughter radionuclide comprises rinsing the column, and thereafter stripping the ²¹³Bi daughter radionuclide from the column into a strip solution.

30. The method according to claim 29, wherein the strip solution is further added to a second column having a sorbent material with higher affinity for the ²²⁵Ac parent radionuclide than for the ²¹³Bi daughter radionuclide and eluting the ²¹³Bi daughter radionuclide from the second column, after interaction between the sorbent material of the second column and remaining ²²⁵Ac parent radionuclide in the strip solution was allowed.
